(19) United States
(12) Patent Application Publication
(10) Pub. No.: US 2009/0044458 A1
(43) Pub. Date: Feb. 19, 2009

(54) SYSTEM FOR INDICATING THE GRADE OF AN ABRASIVE

(75) Inventor: Sandro Giovanni Giuseppe Ferronato, Elburg (NL)

Correspondence Address: YOUNG & THOMPSON, 209 Madison Street, Suite 500, ALEXANDRIA, VA, 22314, US

(73) Assignee: Sandro Giovanni Giuseppe FERRONATO, Elburg (NL)

(21) Appl. No.: 12/281,546

(22) PCT Filed: Mar. 3, 2006
(86) PCT No.: PCT/NL2006/050044

§ 371 Date: Sep. 30, 2008

(51) Int. Cl. C09K 3/14

(52) U.S. Cl. 51/307

(57) ABSTRACT

A system for indicating the nature of an abrasive surface that is determined by an abrasive with a regular pattern, at least a basic portion of which is repeated, which system comprises at least two different abrasive elements that each have an abrasive surface, wherein the basic portion of the pattern of the one abrasive surface has different dimensions to the basic portion of the pattern of the other abrasive surface.

The invention relates to the field of abrasives, both for professional use and in the do-it-yourself trade. Such abrasives can comprise many different materials that are tailored to the characteristics of the surface to be treated. Furthermore, the grade of the abrasive can have various values for obtaining a particular desired effect in the abrasion operations.

With regard to distinguishing between the many different materials that are used for the abrasive, as well as the grade (coarseness) thereof, a range of classifications is used. For example, in the case of sandpaper the grade (coarseness) and the type of abrasive material is often indicated on the back. However, such classifications are not always sufficiently clear, particularly for amateurs.

The aim of the invention is therefore to provide a simpler and therefore more recognisable classification for an abrasive. This aim is achieved by means of a system for indicating the nature of an abrasive surface that is determined by an abrasive with a regular pattern, at least a basic portion of which is repeated, which system comprises at least two different abrasive elements that each have an abrasive surface, wherein the basic portion of the pattern of the one abrasive surface has different dimensions to the basic portion of the pattern of the other abrasive surface.

Because the abrasive is itself applied according to a particular pattern that provides a visual indication of the nature thereof, it can be established directly what type of abrasive it is. For instance, it can, for example, easily be established how coarse the abrasive is.

The visual recognition can be enhanced if the basic portions of the abrasive surface of the abrasive elements are uniform; in particular the size of the basic portions can be a guide to the grade of the abrasive, where preferably a coarser grade is then associated with a larger size for the basic portion.

The pattern can have a wide range of shapes. In particular the basic portion of each pattern can comprise a diamond shape. Such a diamond shape can, for example, be the side view of a polished diamond. These diamond shapes can, in side view, alternate with the point thereof pointing in opposing directions, in such a way that a regular infill is ensured. This is important for obtaining an as regular a result as possible when sanding and also for preventing premature shedding of abrasive.

In addition, the diamond shape can also comprise the top view of a polished diamond. In particular, with such patterns the abrasive can comprise diamond particles, as a result of which the pattern acquires an additional functional value for indicating the material of which the abrasive consists. As an alternative the abrasive can comprise, for example, cubic boron nitride.

The invention will be described in more detail below with reference to a few illustrative embodiments shown in the figures.

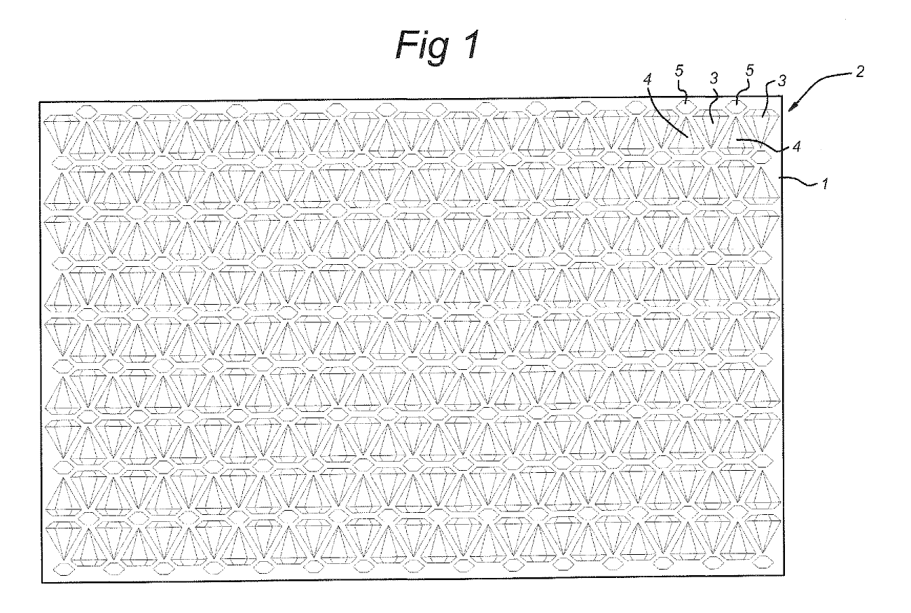

FIGS. 1-3 show three different abrasive elements, in the form of sandpaper or a sanding block here, according to the invention. Each of the abrasives has an abrasive surface 1 with a regular pattern 2 made up of diamond shapes in side view 3 and 4, the point of which points downwards and upwards, respectively. Furthermore, there are diamond shapes 5 in top view. These diamond shapes 3-5 fit into one another in such a way that a regular infill is obtained.

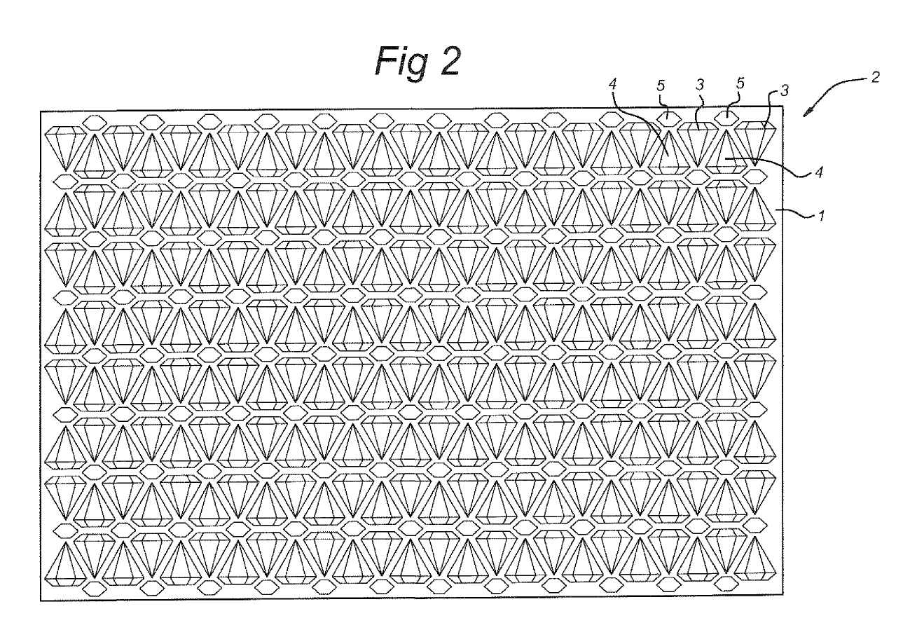

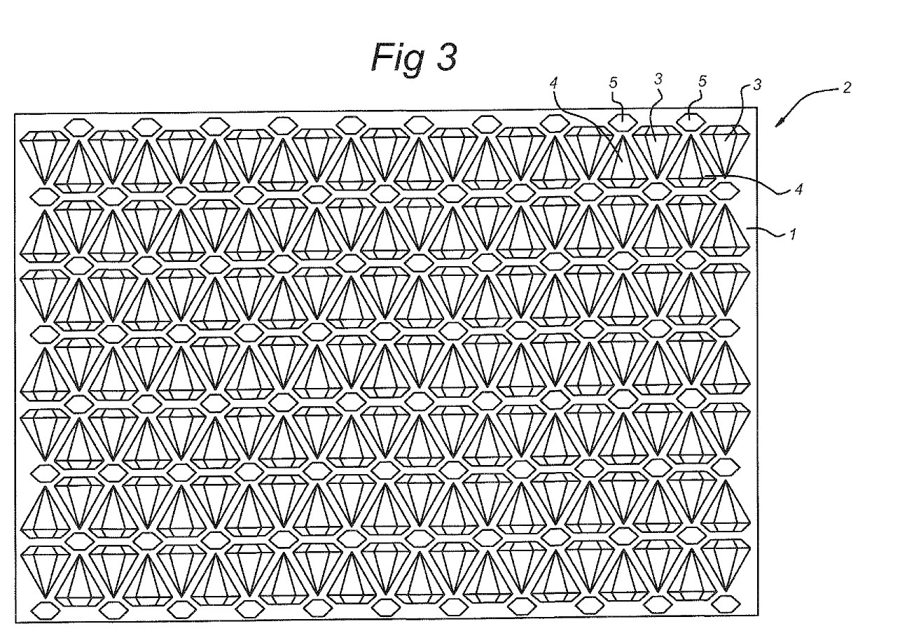

On comparison of FIGS. 1-3 it appears that the size of the diamond shapes 3-5 differ. This means that the abrasive from which the patterns are made up in the variant in FIG. 3 is coarser, in particular is more coarse-grained, than the abrasive that is used in the variant in FIG. 2, which abrasive in FIG. 2 is, in turn, coarser than the abrasive in the variant in FIG. 1.

In particular, in the variant in FIG. 1 the base dimensions of a pattern are 8.3×8.3 mm, in the variant in FIG. 2 11.7×11.7 mm and in the variant in FIG. 3 15×15 mm. The patterns are built up with a line thickness of 0.67/0.7 mm (FIG. 1), 0.7/1.0 mm (FIG. 2) and 0.8/12 mm (FIG. 3).

1. System for indicating the nature of an abrasive surface (1) that is determined by an abrasive with a regular pattern (2), at least a basic portion of which is repeated, which system comprises at least two different abrasive elements that each have an abrasive surface (1), wherein the basic portion (3-5) of the pattern (2) of the one abrasive surface (1) has different dimensions to the basic portion (3-5) of the pattern (2) of the other abrasive surface (1).

2. System according to claim 1, wherein the basic portions (3-5) of the abrasive surface (1) of the abrasive elements are uniform.

3. System according to claim 1, wherein size of the basic portions (3-5) is a guide to the grade of the abrasive.

4. System according to claim 3, wherein a coarser grade is associated with a larger size of the basic portion (3-5).

5. System according to claim 1, wherein the basic portion (3-5) of each pattern (2) comprises a diamond shape.

6. System according to claim 5, wherein the diamond shape is the side view of a polished diamond (3, 4).

7. System according to claim 6, wherein the diamond shapes (3, 4) in side view alternate with the point thereof pointing in opposing directions.

8. System according to claim 5, wherein the diamond shape (5) comprises the top view of a polished diamond.

9. System according to claim 1, wherein the abrasive comprises diamond particles.

10. System according to claim 1, wherein the abrasive comprises cubic boron nitride.

11. System according to claim 2, wherein size of the basic portions (3-5) is a guide to the grade of the abrasive.

12. System according to claim 2, wherein the basic portion (3-5) of each pattern (2) comprises a diamond shape.

13. System according to claim 3, wherein the basic portion (3-5) of each pattern (2) comprises a diamond shape.

14. System according to claim 6, wherein the diamond shape (5) comprises the top view of a polished diamond.

15. System according to claim 7, wherein the diamond shape (5) comprises the top view of a polished diamond.
